(19) United States
(12) Patent Application Publication
(10) Pub. No.: US 2026/0346279 A1
(43) Pub. Date: Nov. 5, 2026

(54) ADJUSTABLE SPRAY HEAD SPRINKLER

(71) Applicant: Hunter Industries, Inc., San Marcos, CA (US)

(72) Inventors: Phat Heng Phung, San Marcos, CA (US); Kevin M. Klein, San Marcos, CA (US)

(21) Appl. No.: 19/198,958

(22) Filed: May 5, 2025

(51) Int. Cl. B05B 3/04; B05B 15/68

(52) U.S. Cl. CPC B05B 3/043; B05B 15/68

(57) ABSTRACT

An adjustable arc irrigation spray nozzle can include one or more features including a crush bead and block to prevent water leakage.

### TECHNICAL FIELD

The present inventions relate to apparatus for irrigating turf and landscaping, and more particularly, to structures for preventing leaks from an adjustable spray head sprinkler.

### BACKGROUND

In many parts of the United States, rainfall is insufficient and/or too irregular to keep turf and landscaping green and therefore irrigation systems are installed. Such systems typically include a plurality of underground pipes connected to sprinklers and valves; the latter being controlled by an electronic irrigation controller. One of the most popular types of sprinklers are spray type sprinklers. Spray type sprinklers are well known in the irrigation art and typically include a spray nozzle that is screwed to the upper end of a fixed vertical riser or a telescoping vertical riser in the case of a so-called pop-up sprinkler. In this type of pop-up sprinkler, a tubular member is normally retracted into an outer cylindrical case by a coil spring. The case is buried in the ground and when pressurized water is fed to the sprinkler the tubular member extends telescopically in an upward direction.

The spray nozzle is usually a generally cylindrical construction made of plastic parts. One type has a fixed arc opening (e.g., 90 degrees, 180 degrees, 360 degrees) which distributes water radially in a relatively thin fan-shaped pattern to close-in vegetation. Another type has an adjustable arc opening. The adjustable arc spray orifice can be adjusted from about 0 degrees to 360 degrees.

### SUMMARY

In some embodiments, an adjustable spray nozzle comprises a lower member and an upper member rotatably coupled to the lower member to vary a size of an arc opening for water to exit the nozzle, the lower member and the upper member defining a path for the water to flow from a passage within the lower member to an exit of the nozzle, the path including an orifice located downstream from the passage, and a crush bead disposed on the lower member so as to contact at least a portion of the upper member to prevent water leakage.

In some embodiments, the lower member comprises a plurality of ribs, and wherein the crush bead is disposed on a surface of a rib of the plurality of ribs.

In some embodiments, the rib is configured as a wall.

In some embodiments, the crush bead extends in a radial direction along a top of the rib.

In some embodiments, the crush bead is disposed outside of both a central hole and a first mating surface of the lower member.

In some embodiments, the first mating surface has a helical shape.

In some embodiments, the upper member comprises a second mating surface configured to contact the first mating surface.

In some embodiments, the crush bead is deformed during assembly of the lower member with the upper member.

In some embodiments, the portion of the upper member comprises a crush bead contact surface.

In some embodiments, the crush bead contact surface has an annular shape.

In some embodiments, an adjustable spray nozzle comprises a lower member and an upper member rotatably coupled to the lower member to vary a size of an arc opening for water to exit the nozzle, the lower member and the upper member defining a path for the water to flow from a passage within the lower member to an exit of the nozzle, the path including an orifice located downstream from the passage, and a block disposed on the upper member so as to contact at least a portion of the lower member to prevent water leakage.

In some embodiments, the block comprises a seal surface extending in an outward radial direction, the seal surface being configured to contact the portion of the lower member.

In some embodiments, the portion of the lower member comprises a block contact surface.

In some embodiments, the lower member comprises a first mating surface, and wherein the block contact surface extends in an outward radial direction from the first mating surface.

In some embodiments, the block contact surface has an annular shape.

In some embodiments, the block contact surface and the first mating surface together have a stepped, planar shape.

In some embodiments, the first mating surface is disposed at an incline in a direction away from a central axis of the nozzle and the block contact surface has a generally horizontal shape.

In some embodiments, an adjustable spray nozzle comprises a lower member and an upper member rotatably coupled to the lower member to vary a size of an arc opening for water to exit the nozzle, the lower member and the upper member defining a path for the water to flow from a passage within the lower member to an exit of the nozzle, the path including an orifice located downstream from the passage, a crush bead disposed on the lower member so as to contact at least a portion of the upper member to prevent water leakage, and a block disposed on the upper member so as to contact at least a portion of the lower member to prevent water leakage.

In some embodiments, the lower member comprises a plurality of ribs, and wherein the crush bead is disposed on a surface of a rib of the plurality of ribs.

In some embodiments, the block comprises a seal surface extending in an outward radial direction, the seal surface being configured to contact the portion of the lower member.

### BRIEF DESCRIPTION OF THE DRAWINGS

FIG. 1 is a perspective view of an adjustable spray nozzle that includes a rotatable upper member which adjusts an arc of spray coverage according to a preferred embodiment of the present invention.

FIG. 2 is a top front perspective view of the adjustable spray nozzle of FIG. 1.

FIG. 3 is a bottom front perspective view of the adjustable spray nozzle of FIG. 1.

FIG. 4 is a side view of an example pop-up irrigation sprinkler that includes an outer tubular member and an inner tubular member in a retracted position within the outer tubular member. The adjustable spray nozzle of FIG. 1 is attached to an end of the inner tubular member.

FIG. 5 is a view similar to FIG. 4 except the inner tubular member has moved from the retracted position illustrated in FIG. 3 to an extended position revealing the adjustable spray nozzle of FIG. 1.

FIG. 6 is a view similar to FIG. 5 except the adjustable spray nozzle has been removed from the end of the inner tubular member and a screen located within the inner tubular member has been removed from the inner tubular member.

FIG. 7 is a top plan view of the adjustable spray nozzle of FIG. 1.

FIG. 8 is a side view of the adjustable spray nozzle of FIG. 1.

FIG. 9 is a cross-section view of the adjustable spray nozzle of FIG. 1 taken along line 9-9 in FIG. 7 and shows the upper member rotatably coupled to the lower member.

FIG. 10 is a top view of an adjustable spray nozzle when in use but having an undesirable leak at a right edge.

FIG. 11 is a top front perspective view of the adjustable spray nozzle of FIG. 8 that includes a crush bead disposed in a path of the right edge to block the leak shown in FIG. 10.

FIG. 12 is a view of the lower member from the adjustable spray nozzle of FIG. 11 showing the crush bead.

FIG. 13 is an enlarged view of a portion of FIG. 12 showing the crush bead prior to assembly of the lower member with the upper member.

FIG. 14 is a top view of an adjustable spray nozzle when in use but having an undesirable leak at a left edge.

FIG. 15 is a top front perspective view of the adjustable spray nozzle of FIG. 8 that includes a block disposed in a path of the left edge to block the leak shown in FIG. 14.

FIG. 16 is a view of the upper member from the adjustable spray nozzle of FIG. 15 showing the block.

FIG. 17 is an enlarged view of a portion of FIG. 16 showing the block.

### DETAILED DESCRIPTION

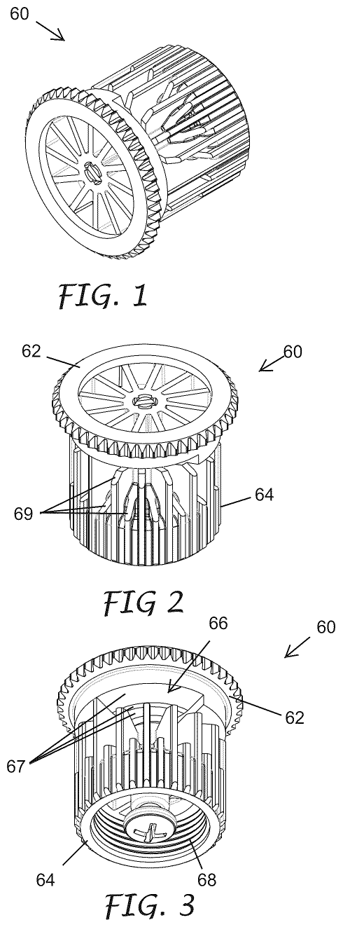

FIG. 1 is a perspective view of an adjustable spray nozzle 60. In certain embodiments, the adjustable spray nozzle 60 includes an upper member 62 and a lower member 64. In the illustrated embodiment, the upper member 62 is rotatable relative to the lower member 64.

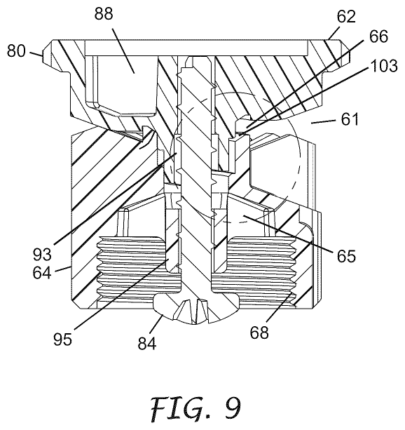

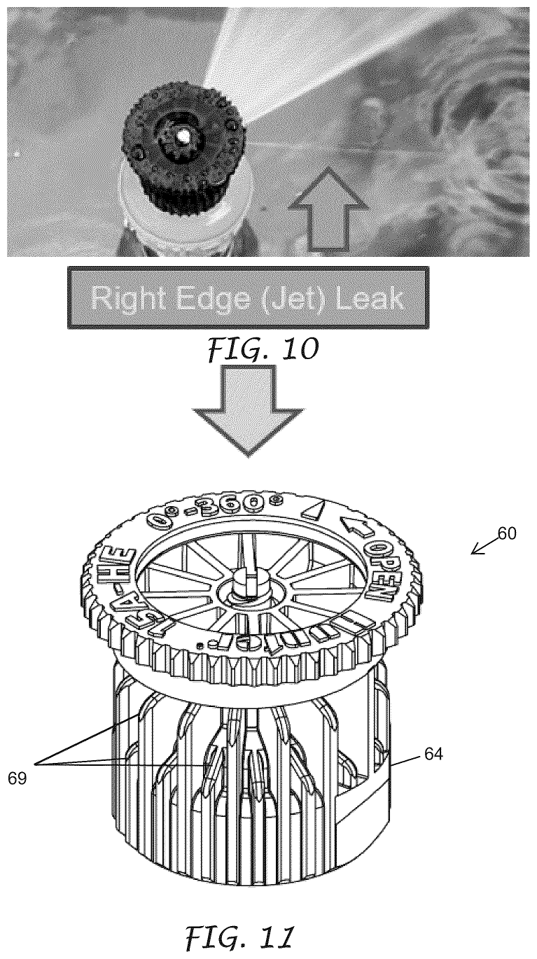

In certain embodiments, the upper member 62 and the lower member 64 together define a flow path 65 (FIG. 9) through the spray nozzle 60 and to an exit 61. In the illustrated embodiment, portions of the flow path 65 are defined by both the upper member 62 and the lower member 64.

In certain embodiments, the flow path 65 comprises one or more orifices 66 arranged in series along the flow path 65 and upstream of the exit 61 (FIG. 9). Rotation of the upper member 62 relative to the lower member 64 adjusts at least a size of an arc of the orifice.

In certain embodiments, surfaces of the exit 61 are disposed downstream of the one or more orifices 66 to direct or deflect water exiting the one or more orifices 66 creating the desired water spray pattern. In certain embodiments, the exit 61 comprises opposing surfaces of the upper member 62 and the lower member 64 that are downstream of the one or more orifices 66. For example, in certain embodiments, the opposing surface of the upper member 62 comprises one or more ramps 67 (FIG. 3) and the opposing surface of the lower member 64 comprises one or more ribs 69. In certain embodiments, the one or more ramps 67 of the upper member 62 defines the spray pattern of the water contacting the ground within the selected size of the arc opening. In certain embodiments, the one or more ramps 67 of the upper member 62 and the one or more ribs 69 of the lower member 64 define the spray pattern of the water contacting the ground within the selected size of the arc opening. In this way, in certain embodiments, a top surface and a bottom surface of the exit 61 is defined by the one or more ramps 67 and the one or more ribs 69, respectively.

FIG. 2 is top front perspective view of the adjustable spray nozzle 60 of FIG. 1. In the illustrated embodiment, clockwise rotation of the upper member 62 relative to the lower member 64 reduces a size of the arc of the one or more orifices 66. Similarly, counterclockwise rotation of the upper member 62 relative to the lower member 64 increases the size of the arc of the one or more orifices 66. In other embodiments, clockwise rotation of the upper member 62 relative to the lower member 64 increases the size of the arc of the one or more orifices 66 while counterclockwise rotation of the upper member 62 relative to the lower member 64 decreases the size of the arc of the one or more orifices 66.

In certain embodiments, the size of the arc of the one or more orifices 66 ranges from 0 degrees to 360 degrees depending on the rotational position of the upper member 62 relative to the lower member 64. In other embodiments, the size of the arc of the one or more orifices 66 has a different range than 0 degrees to 360 degrees. For example, in certain embodiments, the size of the arc of the one or more orifices 66 ranges from 0 degrees to 270 degrees, from 0 degrees to 180 degrees, or from 0 degrees to 90 degrees, or any other desired range.

FIG. 3 is a bottom front perspective view of the adjustable spray nozzle 60 of FIG. 1. In the illustrated embodiment, the spray nozzle 60 has a female threaded segment 68. In certain embodiments, the female threaded segment 68 can be screwed over a male threaded upper end of an inner tubular member 74.

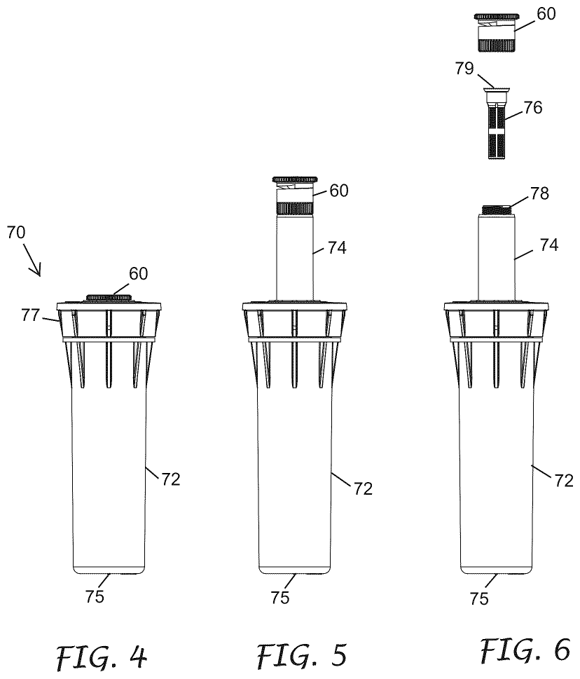

FIG. 4 is a side view of an example pop-up irrigation sprinkler 70 that includes an outer tubular member 72 and the inner tubular member 74 in a retracted position within the outer tubular member 72. Except for the water spray pattern enhancing features described hereafter, the sprinkler 70 can be similar in overall construction and operation to the sprinkler disclosed in the U.S. Pat. No. 10,850,295 granted Dec. 1, 2020, and assigned to Hunter Industries, Inc., the entire disclosure of which is hereby incorporated by reference.

In certain embodiments, the inner tubular member 74 can be a smaller elongate body with an inner passage, an inlet end, and an outlet end. The inner tubular member 74 can be disposed at least partially within the outer tubular member 72. For example, the inner tubular member 74 can be disposed within a fluid passage of the outer tubular member 72. In certain embodiments, the inner tubular member 74 can be substantially concentric with the outer tubular member 72. The adjustable spray nozzle 60 of FIG. 1 is attached to an end of the inner tubular member 74.

FIG. 5 is a view similar to FIG. 4 except the inner tubular member 74 has moved from the retracted position illustrated in FIG. 4 to an extended position revealing the adjustable spray nozzle 60 of FIG. 1. In certain embodiments, the outer tubular member 72 can have an elongate body with an inner passage. The outer tubular member 72 can have an inlet 75 for receiving an inflow of water and an outlet for the water to exit the outer tubular member 72 and enter the inner tubular member 74. In certain embodiments, the inlet 75 can be at a first end of the sprinkler 70.

In certain embodiments, the sprinkler 70 can include a body cap 77. The body cap 77 can be configured to be mounted at or near a second end of the outer tubular member 72. The body cap 77 can have internal threads engaging external threads at or near the second end of the outer tubular member 72.

The inner tubular member 74 can be slide within the inner passage of the outer tubular member 72 along the longitudinal axis of the outer tubular member 72. When not in use (e.g., when pressurized water is not provided to the inlet 75 of the outer tubular member 72) the inner tubular member 74 and the nozzle 60 can be in the retracted position. In certain embodiments, a portion of greater outer diameter of the nozzle 60 can be flush or substantially flush with a flat surface of the body cap 77 when the inner tubular member 74 is in the retracted position. In certain embodiments, a portion of greater outer diameter of the nozzle 60 can be above a flat surface of the body cap 77 when the inner tubular member 74 is in the retracted position. In certain embodiments, the nozzle 60 is at or substantially at a ground surface level when the inner tubular member 74 is in the retracted position.

The inner tubular member 74 can be biased in the retracted position by a coil spring. When in use, pressurized water from the inlet 75 can push the inner tubular member 74 into the extended position. The water pressure can be sufficient to overcome the biasing force of the coil spring. The inner tubular member 74 and the nozzle 60 can telescope from the outer tubular housing 72 in the extended position. In some embodiments, the nozzle 60 can extend above the ground surface level at a predetermined height in the extended position. When the water is turned off, the inner tubular member 74 can return to the retracted position due to the biasing force of the coil spring.

FIG. 6 is a view similar to FIG. 5 except the adjustable spray nozzle 60 has been removed from the end of the inner tubular member 74 and a screen or filter 76 located within the inner tubular member 74 on FIG. 5 has been removed from the inner tubular member 74. In certain embodiments, the screen 76 is inserted into the upper end of the inner tubular member 74 before the spray nozzle 60 is screwed over the same. In certain embodiments, the tip of a small flat-headed screwdriver (not illustrated) may be inserted in a keyway or slot 86 in an upper end of a screw 84 to raise and lower the head of the screw 84 relative to a shoulder of the screen 76 to constrict flow and thereby adjust the radius of the sprinkler 60. In certain embodiments, the screen 76 has a generally cylindrical configuration with a flared upper end 79 that rests on the upper end of the inner tubular member 74 and a lower perforated tubular portion that filters sediment, grit and other debris to prevent it from clogging the one or more orifices 66 of the nozzle 60. In certain embodiments, the screen 76 is injection-molded. As shown in FIG. 6, the inner tubular member 74 can have threads 78 configured to engage the threads 68 in the nozzle 60.

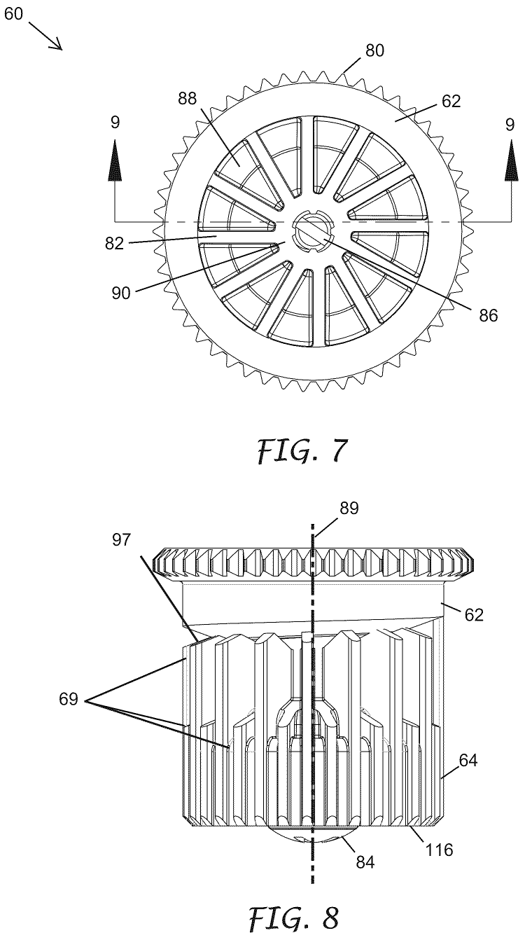

FIG. 7 is a top plan view of the adjustable spray nozzle 60 of FIG. 1. FIG. 8 is a side view of the adjustable spray nozzle 60 of FIG. 1. In the illustrated embodiment, the upper member 62 has a knurled segment 80 that facilitates gripping between the thumb and index finger. In certain embodiments, the upper member 62 is rotatable relative to the lower member 64 about a central axis 89 to select the desired arc size of the water spray pattern when water from the inner tubular member 74 travels through the flow path 65 and is ejected from the exit 61. In certain embodiments, the spray nozzle 60 includes a central sleeve 95 (FIG. 9) through which the screw 84 is threaded. The screw 84 extends at least partially through the spray nozzle 60 with the keyway or slot 86 being accessible from the top of the spray nozzle 60.

In certain embodiments, the upper member 62 includes one or more webs 82 connecting the knurled segment 80 to a central region 90 of the upper member 62. In certain embodiments, the one or more webs 82 can be sized and shaped to transfer rotational motion between the knurled segment 80 and the central region 90 of the upper member 62. In certain embodiments, one or more pockets 88 are formed between the one or more webs 82 and partially defined by sides of each of the one or more webs 82. In certain embodiments, the one or more pockets 88 can reduce the overall mass of the upper member 62 while allowing torque to transfer via the one or more webs 82 to the central region 90.

FIG. 9 is a cross-section view of the adjustable spray nozzle 60 of FIG. 1 taken along line 9-9 in FIG. 7 and shows the upper member 62 rotatably coupled to the lower member 64. A right half of FIG. 9 illustrates the upper member 62 and the lower member 64 together defining the flow path 65 through the spray nozzle 60 and to the exit 61 in the arc region. In the illustrated embodiment, portions of the flow path 65 are defined by both the upper member 62 and the lower member 64. In certain embodiments, the flow path 65 comprises one or more orifices 66 arranged in series along the flow path 65 and upstream of the exit 61.

A left half of FIG. 9 illustrates the upper member 62 and the lower member 64 together closing the flow path 65 through the spray nozzle 60 and to the exit 61 outside the arc region. In this way, the flow path 65 through the spray nozzle 60 can be opened or closed from 0 to 360 degrees.

In certain embodiments, water passes through the filter 76 and enters a passage located near the start of the flow path 65. In certain embodiments, the lower member 64 includes the central sleeve 95 through which the screw 84 is threaded. One or more apertures in the central sleeve 95 allow water from the passage to flow through a central hole within the lower member 64. In the illustrated embodiment, the upper member 62 is screwed over the threaded shank of the screw 84.

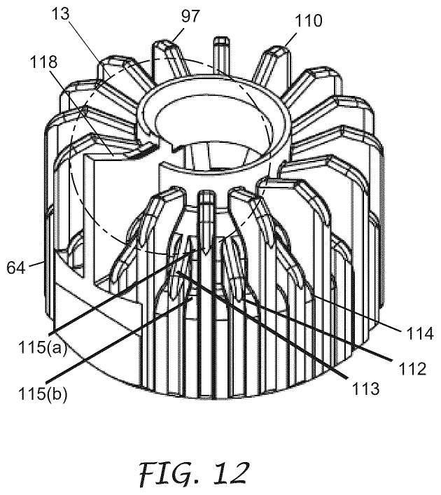

FIG. 10 is a top view of an adjustable spray nozzle when in use but having an undesirable leak at a right edge. FIG. 11 is a top front perspective view of the adjustable spray nozzle 60 of FIG. 8 that includes a crush bead 94 disposed in a path of the right edge to block the leak shown in FIG. 10. FIG. 12 is a view of the lower member 64 from the adjustable spray nozzle 60 of FIG. 11 showing the crush bead 94. The crush bead 94 is not found in the adjustable spray nozzle illustrated in FIG. 10.

In certain embodiments, the exit 61 comprises opposing surfaces of the upper member 62 and the lower member 64 that are downstream of the one or more orifices 66. For example, in certain embodiments, the opposing surface of the upper member 62 comprises the one or more ramps 67 and the opposing surface of the lower member 64 comprises the one or more ribs 69.

In certain embodiments, the one or more ribs 69 (FIG. 8) have similar geometry. For example, in certain embodiments, the one or more ribs 69 have the same geometry. In the illustrated embodiment, the one or more ribs 69 include ribs that have different geometry. Exemplary geometric variations can include height, length, thickness, and orientation relative to the central axis 89.

In the illustrated embodiment, the one or more ribs 69 extend in an upward direction from the bottom surface 116 (FIG. 8) of the lower member 64 to a top surface 97 of the one or more ribs 69. The top surfaces 97 of the one or more ribs 69 form the lower opposing surface of the exit 61. In the illustrated embodiment, the top surfaces 97 of the one or more ribs 69 are located at different heights from the bottom surface 116 and have different contours or profiles.

In certain embodiments, one or more of the top surfaces 97 can have any shape or a combination of shapes. For example, in certain embodiments, one or more of the top surfaces 97 have a planar shape. For example, in certain embodiments, one or more of the top surfaces 97 have a curvilinear shape. In certain embodiments, one or more of the top surfaces 97 can comprise one or more planar surfaces and one or more curved surfaces. In the illustrated embodiment, some of the one or more top surfaces 97 comprise a planar surface while other top surfaces 97 comprise multiple planar surfaces, with still other top surfaces 97 comprising a combination of planar and curvilinear shapes. In certain embodiments, the one or more ribs 69 include ribs that have top surfaces 97 that are located at different distances from the bottom surface 116 of the lower member 64.

In certain embodiments, the one or more ribs 69 include two, three, four, or five different groups of ribs having top surfaces 97 located at different heights from the bottom surface 116. In the illustrated embodiment, the one or more ribs 69 include three different groups of ribs 110, 112, 114. In the illustrated embodiment, the three different groups of ribs include one or more high ribs 110, one or more medium ribs 112, and one or more low ribs 114. Of course, in certain embodiments, the one or more ribs 69 can include more or less than the three groups of ribs illustrated in FIG. 11. For example, in certain embodiment, the one or more ribs 69 include only the one or more high ribs 110 and the one or more low ribs 114.

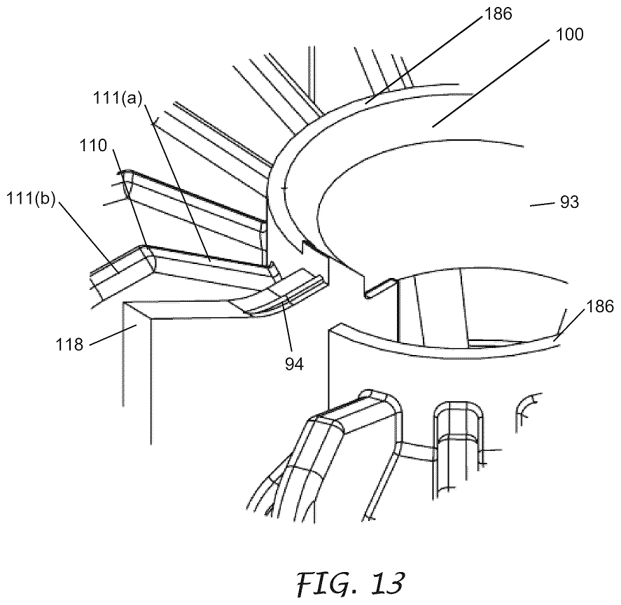

As most clearly shown in FIG. 13, the top surface 97 of the one or more high ribs 110 comprises a first surface 111(a) and a second surface 111(b). In certain embodiments, the first surface 111(a) is planar and disposed at an incline in a direction away from the central axis 89. In certain embodiments, the second surface 111(b) is planar and begins at a distal edge of the first surface 111(a) to form a chamfer at an outer edge of the one or more high ribs 110.

In certain embodiments, the top surface 97 of the one or more medium ribs 112 comprises surface 113. In certain embodiments, the surface 113 is planar and disposed at a decline in a direction away from the central axis 89.

In certain embodiments, the top surface 97 of the one or more low ribs 114 comprises a first surface 115(a) and a second surface 115(b). In certain embodiments, each of the first surface 115(a) and the second surface 115(b) comprises planar and curved portions. In certain embodiments, the planar portion of the first surface 115(a) is disposed at a decline in a direction away from the central axis 89 while the planar portion of the second surface 115(b) is horizontal in a direction away from the central axis 89. In the illustrated embodiment, the surface 113 of the one or more medium ribs 112 is parallel to the planar portion of the first surface 115(a) of the one or more low ribs 114.

In certain embodiments, the one or more ribs 69 extend in a radial direction away from the central axis 89. In certain embodiments, the one or more ribs 69 extend parallel to the direction of water flow exiting the spray nozzle 60. Of course, the one or more ribs 69 need not extend in a radial direction or parallel to the direction of water flow exiting the spray nozzle 60. For example, in certain embodiments, the one or more ribs 69 are canted at an angle relative to the radial direction so as to not be aligned with the central axis 89.

In certain embodiments, the nozzle 60 comprises a plurality of each of the different groups of ribs 110, 112, 114. In the illustrated embodiment, the one or more high ribs 110 include sixteen ribs. In the illustrated embodiment, the one or more medium ribs 112 include fifteen ribs. In the illustrated embodiment, the one or more ribs 69 comprises a wall 118. The wall 118 is disposed between two low ribs 114 in the illustrated embodiment.

In the illustrated embodiment, the one or more low ribs 114 include thirty-two ribs. Of course, other combinations of the number of high, medium, and low ribs 110, 112, 114 and/or the number of groups of ribs 69 falls within this disclosure.

In certain embodiments, the different groups of ribs 110, 112, 114 are spaced about a perimeter of the lower member 64. For example, in the illustrated embodiment, the one or more high ribs 110 including the wall 118 and the one or more medium ribs 112 are interleaved about the perimeter of the lower member 64. In the illustrated embodiment, the one or more low ribs 114 are disposed between each pair of adjacent high ribs 110, the wall 118, and the medium ribs 112. In other embodiments, the ribs within each group of ribs 110, 112, 114 are unequally spaced about a perimeter of the lower member 64.

FIG. 13 is an enlarged view of a portion of FIG. 12 showing the crush bead 94 prior to assembly of the lower member 64 with the upper member 62. In the illustrated embodiment, the crush bead 94 is disposed on the wall 118 of the lower member 64. For example, the crush bead 94 can be disposed on an upper surface of the wall 118. In certain embodiments, the crush bead 94 is disposed so as to contact the one or more ramps 67. In certain embodiments, the one or more of the ramps 67 comprise a crush bead contact surface 96 (FIG. 16). In certain embodiments, the crush bead contact surface 96 is sized and shaped to form an interference fit with the crush bead 94 during assembly of the upper member 62 with the lower member 64.

While the crush bead 94 is illustrated in combination with certain features, for example, the one or more ribs 69 and the one or more ramps 67, the crush bead 94 can be employed in a nozzle 60 that does not include at least those other features.

The crush bead 94 is disposed outside of both the central hole 93 (FIG. 13) and a first mating surface 100. As explained above, in certain embodiments, the crush bead 94 is deformed during assembly of the lower member 64 with the upper member 62. Specifically, during assembly, a lower portion of the crush bead contact surface 96 contacts a top surface of the crush bead 94. The contact between the crush bead contact surface 96 and the crush bead 94 deforms the crush bead (e.g., changes shape) 94 so that a shape of the crush bead 94 changes from a first shape to a second shape. Unlike a contour of the first shape, a contour of the second shape matches the crush bead contact surface 96 of the upper member 62 which reduces and in many cases prevents leakage from a right side of the adjustable spray nozzle 60 at the end point or wall 118. For example, due to variability in manufacturing and without the crush bead 94, the wall 118 can have some leakage due to small gaps between the wall 118 and the upper member 62. In contrast, the crush bead 94 and the crush bead contact surface 96 inhibit water within the spray nozzle 60 from flowing over the wall 118 and exiting the nozzle 60 as shown in FIG. 10.

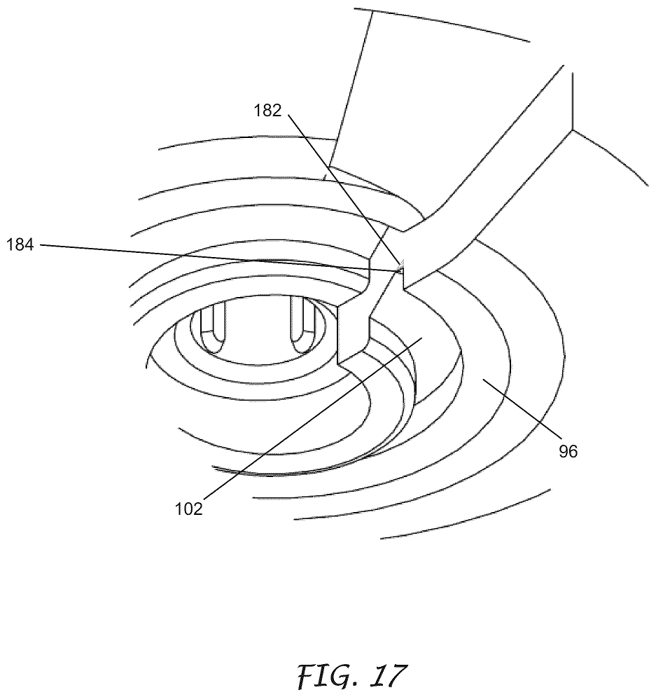

In certain embodiments, the first mating surface 100 has a helical shape relative to the central hole 93. In the illustrated embodiment, the first mating surface 100 is configured to contact a second mating surface 102 (FIG. 17) of the upper member 62. In certain embodiments, the second mating surfaces 102 has a helical shape relative to the central hole 93. In certain embodiments, the second mating surface 102 follows a helical shape from a low point to a high point. In the illustrated embodiment, the second mating surface 102 is at least partially formed by an edge of the upper member 62. In certain embodiments, the second mating surface 102 has a generally curved shape. Of course, the second mating surface 102 can have any shape and is not limited to being curved. For example, in certain embodiments, the second mating surface 102 has a planar shape.

In certain embodiments, the upper member 62 comprises a wall 120 at a high point of the second mating surface 102 (FIG. 16). In the illustrated embodiment, the wall 120 is arranged in a vertical direction. In other embodiments, the wall 120 is not vertical. For example, in certain embodiments, the angle of the wall 120 is complementary to the angle of the wall 118 so that the wall 120 engages with the wall 118 when the spray nozzle 60 is fully closed or when the arc opening is zero.

In certain embodiments, the wall 120 is configured to contact the wall 118 on the lower member 64 when the spray nozzle 60 is fully closed or when the arc opening is zero. In certain embodiments, a portion of the wall 120 is configured to contact the first mating surface 100 on the lower member 64 when the spray nozzle 60 is fully closed or when the arc opening is zero. In certain embodiments, water is prevented from exiting between the walls 118, 120 of the spray nozzle 60 when in the fully closed position. As the upper member 62 is slowly rotated in a counterclockwise direction relative to the lower member 64, the wall 120 slowly moves away from the wall 118 along the helical path allowing water to exit the spray nozzle 60 in the arc opening.

In certain embodiments, the lower member 64 comprises the crush bead 94. In certain embodiments, the crush bead 94 projects from a side or edge of the wall 118 in an upward direction. In certain embodiments, the crush bead 94 extends in an upward direction along a side or edge of the wall 118. In certain embodiment, a height of the crush bead 94 varies along a radial length of the crush bead 94. In certain embodiments, the crush bead 94 projects in a plane defined by the wall 118. In certain other embodiments, the crush bead 94 is offset from a plane defined by the wall 118. In certain other embodiments, the crush bead 94 is continuous with the wall 118. In certain embodiments, a width of the crush bead 94 matches a width of the wall 118. In the illustrated embodiment, the width of the crush bead 94 is less than a width of the wall 118. In still other embodiments, the width of the crush bead 94 varies along a length of the crush bead 94. For example, in certain embodiments, the width of the crush bead 94 tapers in width along at least a portion of its length.

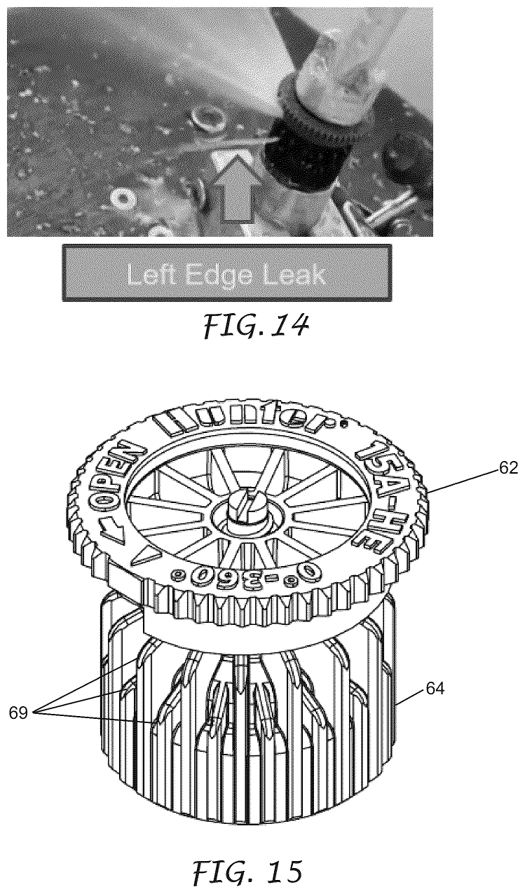

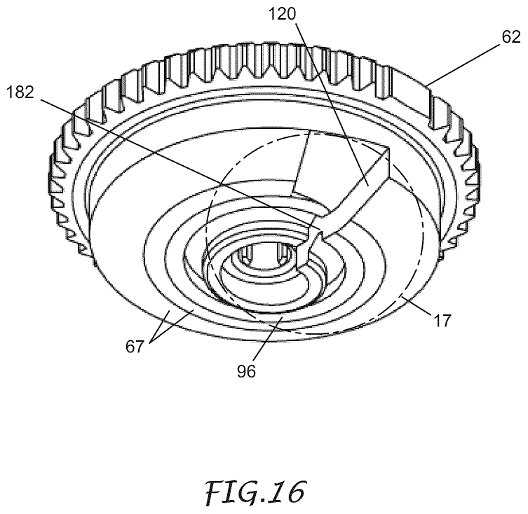

FIG. 14 is a top view of an adjustable spray nozzle when in use but having an undesirable leak at a left edge. FIG. 15 is a top front perspective view of the adjustable spray nozzle of FIG. 8 that includes a block 182 disposed in a path of the left edge to block the leak shown in FIG. 14. FIG. 16 is a view of the upper member 62 from the adjustable spray nozzle 60 of FIG. 8 showing the block 182. In the illustrated embodiment, the block 182 is a wedge-shaped or triangular shaped portion or region of the upper member 62 that is located adjacent to the second mating surface 102. The block 182 is a unitary portion of the upper member 62. FIG. 17 is an enlarged view of a portion of FIG. 16 showing the block 182. In certain embodiments, a bottom or lower surface of the block 182 comprises a seal surface 184. In the illustrated embodiment, the seal surface 184 extends in an outward radial direction from the second mating surface 102 so as to contact or at least come in close contact with at least a portion of a block contact surface 186 (FIG. 13). The seal surface 184 is sized and shaped to form a seal with the block contact surface 186. For example, in certain embodiments, the seal surface 184 and the block contact surface 186 form generally flat surfaces which stay in sufficiently close proximity to each other to form a seal as the upper member 62 is rotated relative to the lower member 64. In this way, water is prevented from leaking between the seal surface 184 and the block contact surface 186. In the illustrated embodiment, the seal surface 184 is disposed at a left edge of the upper member 62 so as to block the left edge leak illustrated in FIG. 14.

In the illustrated embodiment of FIG. 13, the block contact surface 186 on the lower member 64 has an annular shape. In the illustrated embodiment, the block contact surface 186 has a shape that is different than the shape of the first mating surface 100. In this way, the block contact surface 186 and the first mating surface 100 together have a stepped, planar shape. For example, in certain embodiments, the first mating surface 100 is disposed at an incline in a direction away from the central axis 89 while the block contact surface 186 has a generally horizontal shape. In certain embodiments, the block contact surface 186 is planar and begins at an outer edge of the first mating surface 100. In other embodiments, the block contact surface 186 and the first mating surface 100 together have a curvilinear shape in a radial direction. In certain embodiments, the shape comprises two or more line segments. In certain embodiments, the two or more lines have different lengths. Of course, the shape can be formed from any combination of one or more arcs, curves, or line segments.

In certain embodiments, a width measured in the vertical direction of a gap 103 (FIG. 9) within the arc opening does not vary when the upper member 62 is manually rotated relative to the lower member 64. This allows a user to select a desired size of the arc of the water spray pattern caused by water exiting without changing the water spray pattern within the arc opening. In certain other embodiments, the gap 103 varies in width along at least a portion of the length of the arc opening. For example, the gap 103 can have a variable width for at least a portion of the length of the arc opening.

In certain embodiments, at least a portion of the one or more ramps 67 defines a convex surface. In certain embodiments, the convex surface is a curved surface. In certain embodiments, the curved surface comprises two or more arcs or curves. In certain embodiments, the two or more arcs or curves have different radii. In certain embodiments, the convex surface comprises two or more line segments. In certain embodiments, the two or more lines have different lengths. Of course, the convex surface can be formed from any combination of one or more arcs, curves, or line segments.

While I have described an embodiment of an adjustable arc irrigation spray nozzle configured for enhanced watering while preventing leaks, it will be apparent to those skilled in the art that my invention can be modified in both arrangement and detail. Therefore, the protection afforded my invention should only be limited in accordance with the scope of the following claims.

Although certain embodiments and examples are disclosed herein, inventive subject matter extends beyond the examples in the specifically disclosed embodiments to other alternative embodiments and/or uses, and to modifications and equivalents thereof. Thus, the scope of the claims appended hereto is not limited by any of the particular embodiments described above. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

For expository purposes, the term “horizontal” as used herein is defined as a plane parallel to the plane or surface of the floor or ground of the area in which the device being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

Although the nozzle has been disclosed in the context of certain embodiments and examples, it will be understood by those skilled in the art that the nozzle and subassemblies extend beyond the specifically disclosed embodiments to other alternative embodiments and/or uses of the embodiments and certain modifications and equivalents thereof. Accordingly, it is intended that the scope of the nozzle herein-disclosed should not be limited by the particular disclosed embodiments described above but should be determined only by a fair reading of the claims that follow.

What is claimed is:

1. An adjustable spray nozzle comprising:
a lower member and an upper member rotatably coupled to the lower member to vary a size of an arc opening for water to exit the nozzle, the lower member and the upper member defining a path for the water to flow from a passage within the lower member to an exit of the nozzle, the path including an orifice located downstream from the passage; and
a crush bead disposed on the lower member so as to contact at least a portion of the upper member to prevent water leakage.

2. The adjustable spray nozzle of claim 1, wherein the lower member comprises a plurality of ribs, and wherein the crush bead is disposed on a surface of a rib of the plurality of ribs.

3. The adjustable spray nozzle of claim 2, wherein the rib is configured as a wall.

4. The adjustable spray nozzle of claim 2, wherein the crush bead extends in a radial direction along a top of the rib.

5. The adjustable spray nozzle of claim 1, wherein the crush bead is disposed outside of both a central hole and a first mating surface of the lower member.

6. The adjustable spray nozzle of claim 5, wherein the first mating surface has a helical shape.

7. The adjustable spray nozzle of claim 5, wherein the upper member comprises a second mating surface configured to contact the first mating surface.

8. The adjustable spray nozzle of claim 1, wherein the crush bead is deformed during assembly of the lower member with the upper member.

9. The adjustable spray nozzle of claim 1, wherein the portion of the upper member comprises a crush bead contact surface.

10. The adjustable spray nozzle of claim 9, wherein the crush bead contact surface has an annular shape.

11. An adjustable spray nozzle comprising:
a lower member and an upper member rotatably coupled to the lower member to vary a size of an arc opening for water to exit the nozzle, the lower member and the upper member defining a path for the water to flow from a passage within the lower member to an exit of the nozzle, the path including an orifice located downstream from the passage; and
a block disposed on the upper member so as to contact at least a portion of the lower member to prevent water leakage.

12. The adjustable spray nozzle of claim 11, wherein the block comprises a seal surface extending in an outward radial direction, the seal surface being configured to contact the portion of the lower member.

13. The adjustable spray nozzle of claim 12, wherein the portion of the lower member comprises a block contact surface.

14. The adjustable spray nozzle of claim 13, wherein the lower member comprises a first mating surface, and wherein the block contact surface extends in an outward radial direction from the first mating surface.

15. The adjustable spray nozzle of claim 13, wherein the block contact surface has an annular shape.

16. The adjustable spray nozzle of claim 14, wherein the block contact surface and the first mating surface together have a stepped, planar shape.

17. The adjustable spray nozzle of claim 16, wherein the first mating surface is disposed at an incline in a direction away from a central axis of the nozzle and the block contact surface has a generally horizontal shape.

18. An adjustable spray nozzle comprising:
a lower member and an upper member rotatably coupled to the lower member to vary a size of an arc opening for water to exit the nozzle, the lower member and the upper member defining a path for the water to flow from a passage within the lower member to an exit of the nozzle, the path including an orifice located downstream from the passage;
a crush bead disposed on the lower member so as to contact at least a portion of the upper member to prevent water leakage; and
a block disposed on the upper member so as to contact at least a portion of the lower member to prevent water leakage.

19. The adjustable spray nozzle of claim 18, wherein the lower member comprises a plurality of ribs, and wherein the crush bead is disposed on a surface of a rib of the plurality of ribs.

20. The adjustable spray nozzle of claim 18, wherein the block comprises a seal surface extending in an outward radial direction, the seal surface being configured to contact the portion of the lower member.
